(19) United States
(12) Patent Application Publication
(10) Pub. No.: US 2017/0068955 A1
(43) Pub. Date: Mar. 9, 2017

(54) VERIFICATION AND PROVISIONING OF MOBILE PAYMENT APPLICATIONS

(71) Applicant: CA, INC., New York, NY (US)

(72) Inventor: Gaurav AGARWAL, Bangalore (IN)

(73) Assignee: CA, INC., New York, NY (US)

(21) Appl. No.: 14/845,341

(22) Filed: Sep. 4, 2015

(51) Int. Cl. G06Q 20/38; G06Q 20/32; G06Q 20/20; G06Q 20/40

(52) U.S. Cl. CPC G06Q 20/3829; G06Q 20/4012; G06Q 20/3278; G06Q 20/206; G06Q 2220/00

(57) ABSTRACT

A method includes receiving a provisioning request from a payment application, the provisioning request requesting allocation of a payment key, obtaining a checksum of the payment application, generating the payment key, encrypting the payment key using the checksum of the payment application to provide an encrypted payment key, and transmitting the encrypted payment key to the payment application.

### FIELD

The inventive concepts described herein relate to software applications for computing devices. In particular, the inventive concepts relate to computer systems and software applications and related methods that verify the integrity of mobile payment applications.

### BACKGROUND

Chipcards are credit or debit cards that contain electronic chips that store data and algorithms that are used to secure financial transactions. With the proliferation of mobile devices, the card payment industry is moving toward payment using the equivalent of a chipcard stored on a mobile device. For mobile payment, the same data and algorithms that are stored on chipcards can be stored on a mobile device, and the payment credential is still called a “card” even though it no longer physically resides in a plastic card. As used herein, the word “card” can refer either to a chipcard or an electronic equivalent of a chipcard stored on a mobile device.

The “Europay, Mastercard and Visa” (EMV) consortium has defined specifications for mobile cards that work within a secure payment infrastructure. All major card brands, including Visa, Mastercard, American Express, Discover, etc., have developed card specifications that derive from the EMV specifications.

In some variants, a card contains secret cryptographic keys that are stored securely and that are used to digitally sign transaction data relating to a potential transaction, such as a credit card transaction or a debit card transaction. Cryptographic payment keys may be referred to herein as “cryptographic keys” or “payment keys”. The digitally signed transaction data may be used to verify the transaction, which may provide enhanced security relative to a conventional credit/debit card transaction. Such a card can be used, for example, at a merchant point of sale (POS) terminal, an automatic teller machine (ATM) or other location.

### SUMMARY

A method according to some embodiments includes receiving a provisioning request from a payment application, the provisioning request requesting allocation of a payment key, obtaining a checksum of the payment application, generating the payment key, encrypting the payment key using the checksum of the payment application to provide an encrypted payment key, and transmitting the encrypted payment key to the payment application.

Obtaining the checksum of the payment application may include sending a message to a network node operated by a publisher of the payment application and receiving the checksum of the payment application in response from the network node operated by the publisher of the payment application.

The method may further include receiving a version number of the payment application, wherein obtaining the checksum of the payment application may include sending a message to a network node operated by a publisher of the payment application including the version number of the payment application and receiving the checksum from the network node operated by the publisher of the payment application in response.

The method may further include receiving a version number of the payment application,

determining if the version number of the payment application is supported for mobile payments, and in response to determining that the version number of the payment application is not supported for mobile payments, generating an encrypted payment key by encrypting the payment key using a checksum for an updated version of the payment application that is supported for mobile payments.

The method may further include identifying an installed version of the payment application,

determining if the installed version of the payment application is an outdated version of the payment application, in response to determining that the installed version of the payment application is an outdated version of the payment application, sending a message to a user of the payment application indicating that the payment application should be upgraded to a newer version before generating the payment key and preventing generation of a payment key for the payment application until the payment application has been upgraded to the newer version.

The method may further include invalidating payment keys generated using a checksum of the installed version of the payment application in response to determining that the installed version of the payment application is an outdated version of the application.

The method may further include notifying a payment processing server that the payment keys generated using a checksum of the installed version of the payment application have been invalidated.

The method may further include, in response to determining that the installed version of the payment application is an outdated version of the payment application, obtaining a checksum of a current version of the payment application and encrypting the payment key using the checksum of the current version of the payment application to provide the encrypted payment key.

Obtaining the checksum of the payment application may include sending a request for the checksum to an operating system component on a processing device on which the payment application is running and receiving the checksum of the payment application from the operating system component.

A computer system according to some embodiments includes a processor and a memory coupled to the processor. The memory includes computer readable program code embodied therein that, when executed by the processor, causes the processor to perform operations including receiving a provisioning request from a payment application, the provisioning request requesting allocation of a payment key, obtaining a checksum of the payment application, generating a payment key, encrypting the payment key using the checksum of the payment application to provide an encrypted payment key, and transmitting the encrypted payment key to the payment application.

A method according to some embodiments includes receiving an encrypted payment key from a provisioning server, obtaining a checksum of a payment application, decrypting the encrypted payment key using the checksum of the payment application to obtain a decrypted payment key, generating a cryptogram for use in a secure transaction by the payment application using the decrypted payment key, and initiating a secure transaction using the cryptogram.

The checksum of the payment application may include a hash of the payment application.

Decrypting the encrypted payment key may include performing an exclusive-OR operation on the encrypted payment key and the checksum of the payment application.

The method may further include obtaining a personal identification number (PIN) for a user of the payment application, and decrypting the encrypted payment key may include decrypting the encrypted payment key using a combination of the checksum of the payment application and the PIN to obtain the decrypted payment key.

Decrypting the encrypted payment key may include performing an exclusive-OR operation on the encrypted payment key, the checksum of the payment application and the PIN.

The method may further include sending a provisioning request to the provisioning server requesting that the provisioning server provide the payment key for use in securing online transactions.

The method may further include obtaining a personal identification number (PIN) for a user of the payment application, encoding the encrypted payment key using the PIN to obtain a PIN-encoded encrypted payment key, and storing the PIN-encoded encrypted payment key.

The provisioning request may include a version number of a payment application that is requesting provisioning.

Obtaining the checksum may include obtaining the checksum from an operating system component that is running on the computing device.

Other methods, computer program products, and/or electronic devices according to embodiments of the present disclosure will be or become apparent to one with skill in the art upon review of the following drawings and detailed description. It is intended that all such methods, computer program products, and/or electronic devices be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIGS. 1 and 2 are block diagrams that illustrate chipcard transactions.

FIG. 3 is a block diagram illustrating various elements of a system according to some embodiments.

FIGS. 4A, 4B, 5A, 5B, 5C and 5D are flow diagrams illustrating operations of various elements of a system according to some embodiments.

FIG. 6 is a block diagram illustrating a provisioning server according to some embodiments.

FIG. 7 is a block diagram illustrating a mobile computing device according to some embodiments.

FIG. 8-12 are flowcharts illustrating operations according to some embodiments.

### DETAILED DESCRIPTION OF EMBODIMENTS

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

In recent years, the EMV consortium has designed a payment solution whereby the card data and algorithms can be stored on a mobile computing device instead of in a physical card. In this context, the mobile computing device may include a mobile telephone, smartphone, tablet, laptop, personal digital assistant (PDA) or any other mobile computing device. However, the term “mobile computing device” or “mobile device” is not limited to wireless computing devices. The payment credential on the mobile device may still be called a “card” for convenience.

For simplicity, the following discussion will be limited to a description of point of sale purchases. However, the description is equally applicable to ATM and similar transactions.

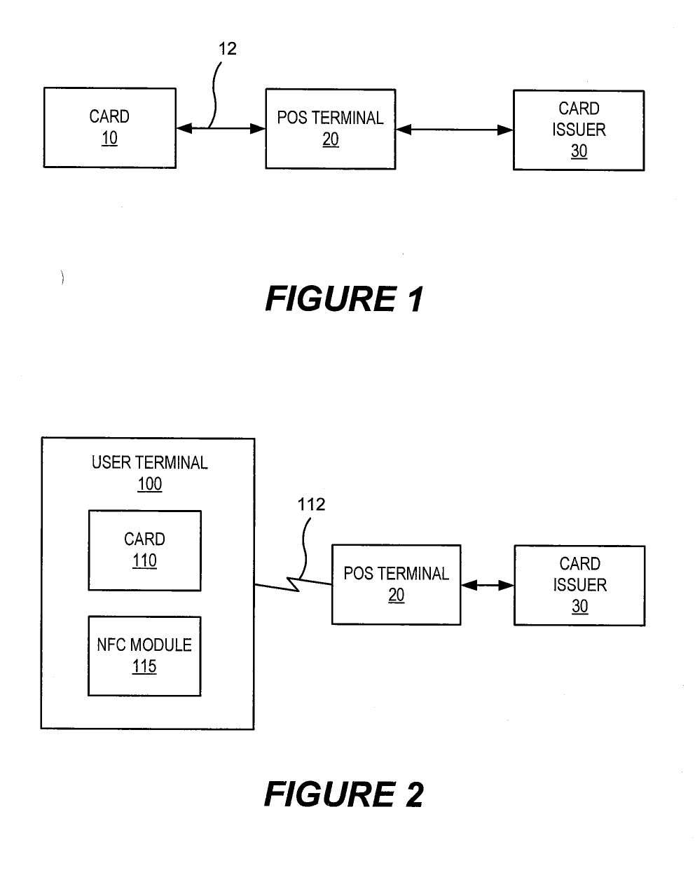

Referring to FIG. 1, during a card purchase, a card 10 exchanges a plurality of messages with a Point-Of-Sale (POS) terminal 20 via a communication link 12. The card 10 and the POS terminal 20 negotiate whether the transaction will be performed, and if so, how it will be performed. Information received by the POS terminal 20 may be used to verify the transaction with the card issuer 30.

The card 10 may be an EMV card, i.e. any card that complies with the EMV standards, or other similar technology, or any other card that includes a processor and memory.

To communicate with a merchant POS terminal, a user terminal may use near field communications (NFC) instead of the physical electrical contact used for a card. Near field communication (NFC) is a set of standards that enable short-range, bidirectional wireless communication between devices by touching them together or bringing them into close proximity, usually no more than a few inches. NFC standards cover communications protocols and data exchange formats, and are based on existing radio-frequency identification (RFID) standards.

Referring to FIG. 2, a mobile device 100 may include electronic payment credentials, i.e. a “card” 110 stored in a memory of the mobile device 100, and an NFC module 115. The NFC module may include a transceiver and associated software and/or firmware that enables the mobile device 100 to engage in NFC communications. To use the NFC-enabled mobile device 100 to conduct a transaction, the mobile device 100 may be placed against (or close to) the POS terminal 20 for several seconds, during which time a wireless communication path 112 is established between the mobile device 100 and the POS terminal 20. The transaction may be negotiated between the card 110 and the POS terminal using the wireless communication path 112.

Other types of wireless communication protocols, such as Bluetooth and Wi-Fi may be used to establish the wireless communication path 112.

The electronic payment credentials in the card 110 may include cryptographic keys that are used to digitally sign transaction data for verification/authentication purposes. For security purposes, it is generally not desirable to store this sensitive data in a normal memory that may be subject to tampering or hacking. Instead, cards are typically stored within a “Secure Element” (SE), which is a tamper-resistant chip that provides secure data storage along with a cryptographic microprocessor to facilitate transaction authentication and security, and provide secure memory for storing payment applications. Payment applications can also run within the Secure Element.

However, it may be impractical or otherwise undesirable to include or use a Secure Element in a mobile device. This leads to a potential problem, in that a cryptographic key stored in a mobile device may be compromised if the mobile device is lost or stolen. Some embodiments provide methods of generating, storing and/or using cryptographic keys in such a manner that they are less likely to be compromised even if they are not stored in a Secure Element or similar environment.

Cryptographic keys are provided to mobile payment applications in a mobile terminal in a process referred to as “provisioning.” Provisioning may be performed by a provisioning server that authenticates the mobile payment application and ensures that the correct cryptographic keys are being supplied to an authorized mobile payment application on the mobile device.

Although the use of mobile applications for payment using cryptographic keys can be very convenient for consumers, mobile payment applications on mobile computing devices may be more susceptible to tampering than conventional chipcards. It may therefore be important to verify the integrity of a mobile payment application which is used generate a payment cryptogram. That is, it may be important to verify that an up-to-date version of the payment application is running on the mobile computing device, and that the payment application has not been tampered with.

According to some embodiments, the integrity of a payment application can be verified at the time the payment application is provisioned with cryptographic payment keys by a provisioning server. In particular, the integrity of a payment application can be verified by encrypting the cryptographic payment key using a checksum of a valid/current version of the mobile payment app. Unless the payment application decrypts the encrypted payment key using the checksum of the valid/current version of the mobile payment app, the decoded payment key will not be valid, and will be rejected if it is attempted to be used to conduct a transaction.

According to some embodiments, a provisioning server can encode the cryptographic payment key by XORing the payment key with a checksum of the mobile payment application. When generating a cryptogram to be used in a transaction, the mobile payment application can recover the correct cryptographic payment key by XORing the encrypted key with a dynamically calculated checksum of the mobile payment application. The correct cryptographic payment key will be recovered only if calculated checksum and expected checksum are equal. Thus, a valid cryptogram can only be calculated by a genuine application.

Moreover, encrypting the cryptographic payment key with a checksum of a valid mobile payment application may enforce version control over the mobile payment application. That is, if an updated version of the mobile payment application is released, the provisioning server may encrypt new cryptographic payment keys with a checksum of the updated application version. Unless the mobile payment application is updated to the new version, the mobile payment application will be unable to successfully decode the cryptographic payment key, and any transaction that the payment application attempts to conduct using the incorrect payment key will fail.

As will be appreciated, a checksum or hash sum is a relatively small value that is generated from a larger block of digital data for the purpose of detecting errors which may have been introduced during transmission or storage of the data. For example, after a file has been downloaded, a checksum of the downloaded file may be calculated and compared to a value that is received along with the file. If the checksum values match, there is a high probability that the file was not altered or corrupted during the download. Thus, for example, checksums are commonly used to verify the integrity of an application installation file after it has been downloaded server. Thus, a checksum may be thought of as a signature of a file.

The procedure for generating a checksum is referred to as a checksum function or checksum algorithm. Checksum functions can be simple, such as by adding the bytes of a file together and discarding carry bits, or complex, such as cryptographic hash functions or secure hashing algorithms, depending on the sensitivity required, the amount of processing time allowed, and other factors.

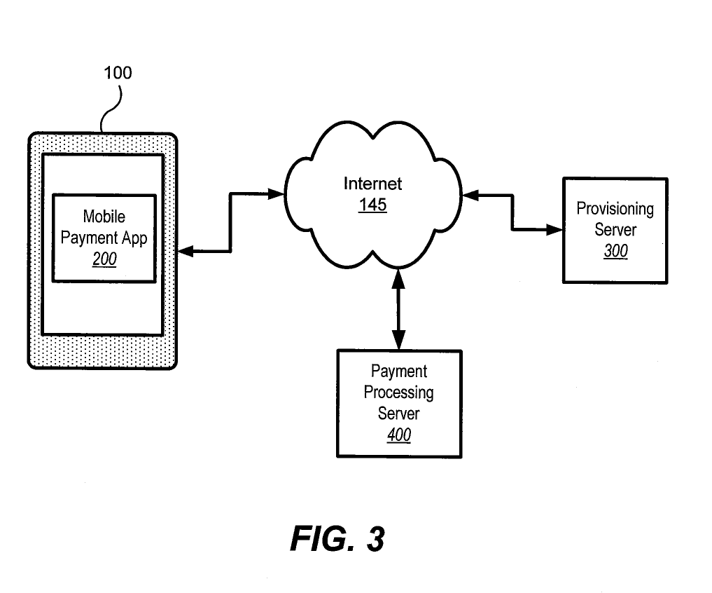

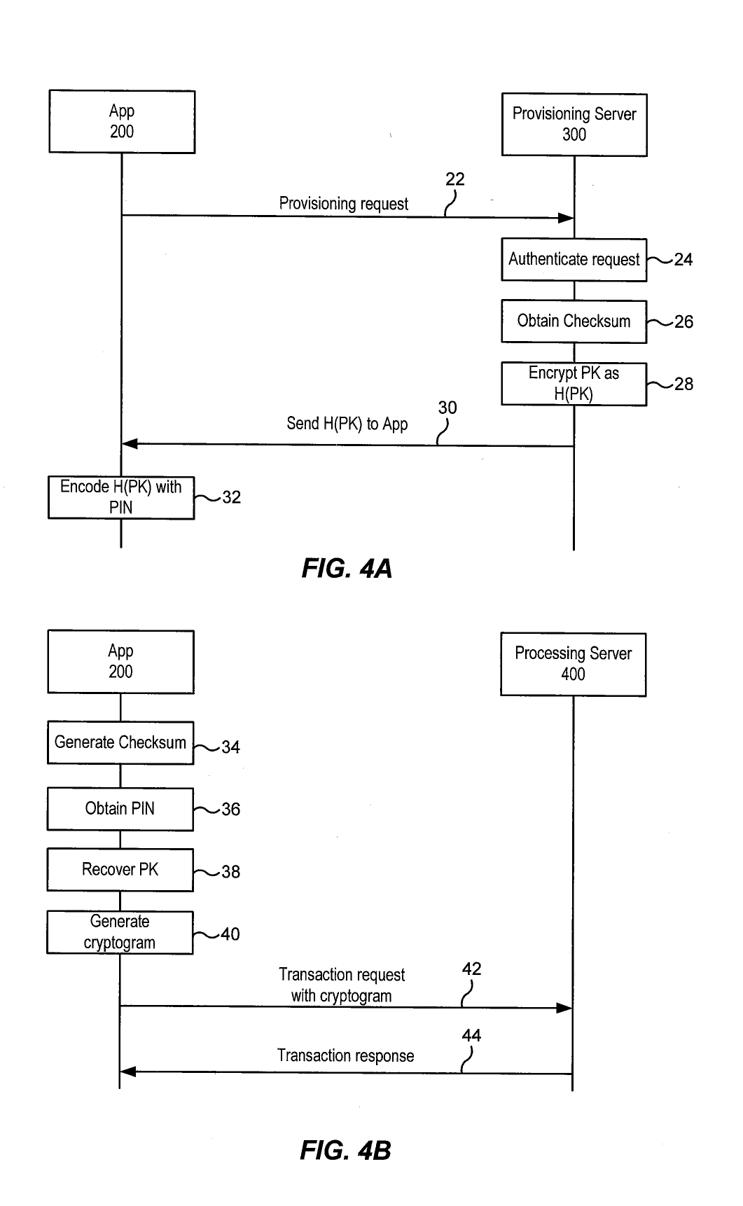

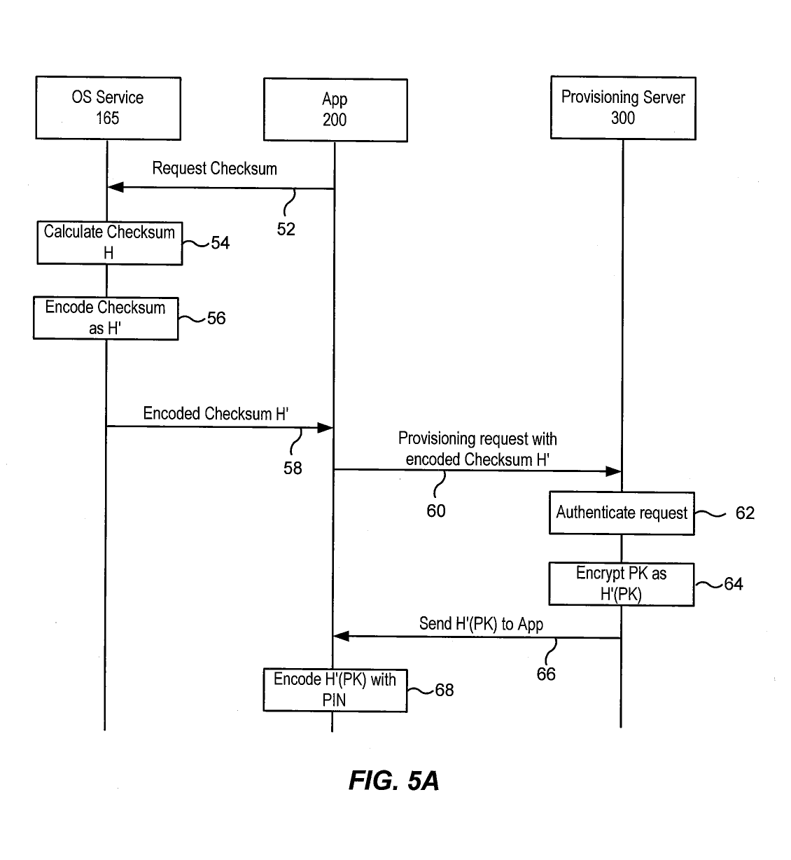

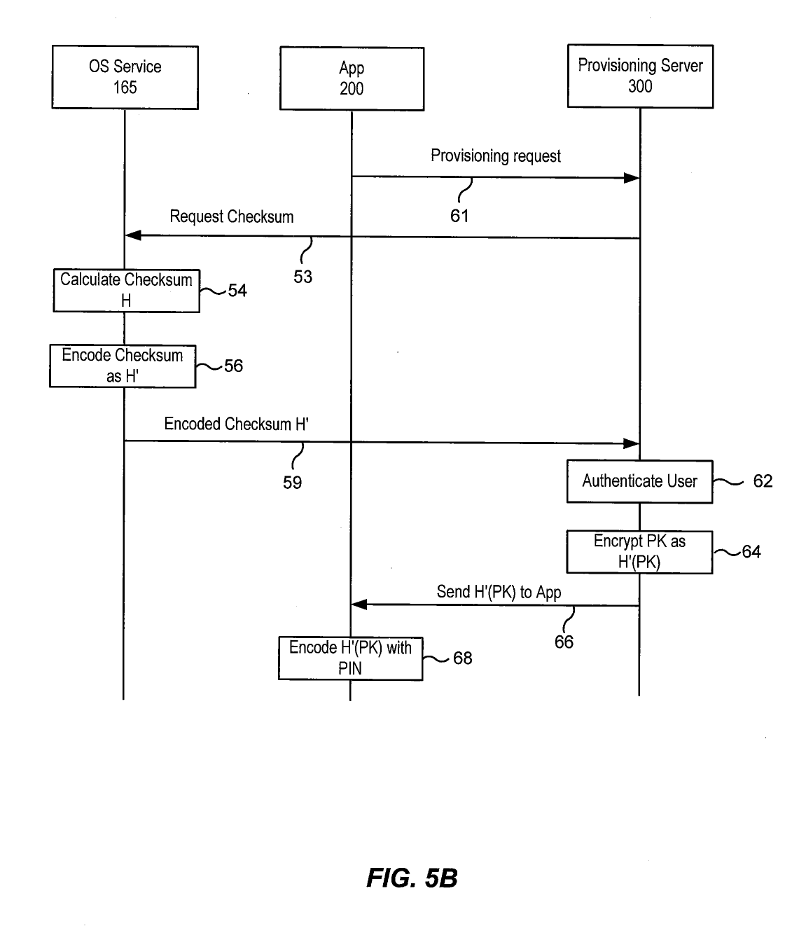

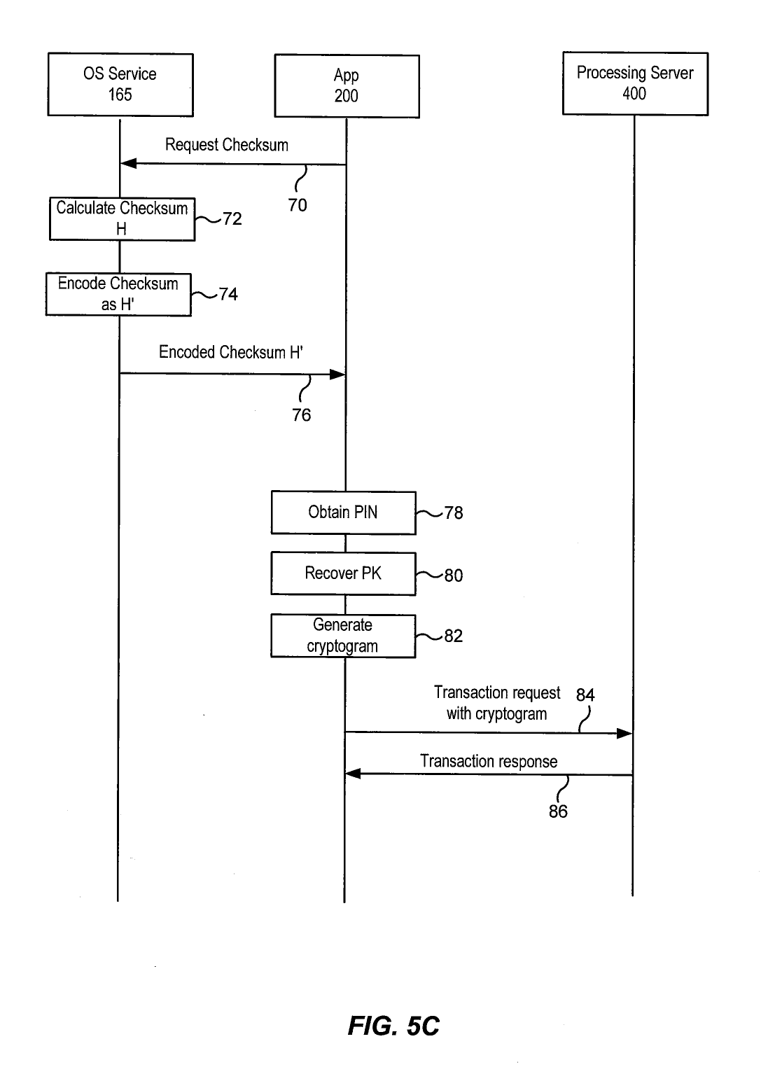

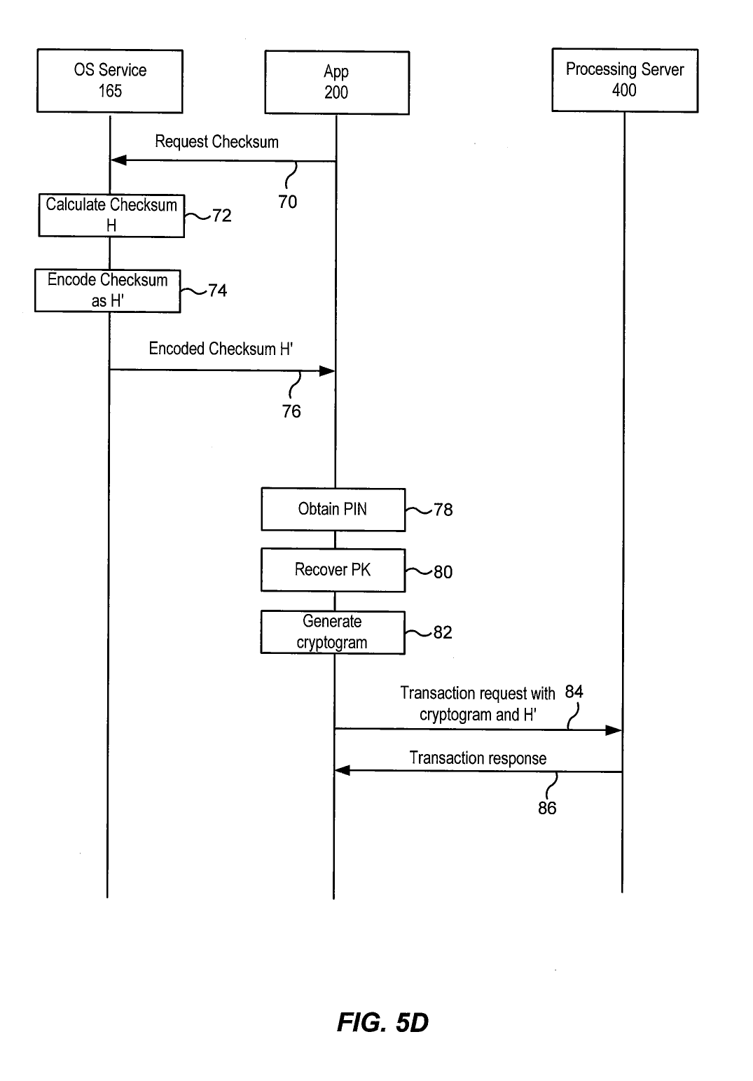

FIG. 3 is a block diagram illustrating various elements of a system for provisioning a payment application in a mobile computing device according to some embodiments, and FIGS. 4 and 5 are flow diagrams illustrating operations of various elements of a system for provisioning a payment application in a mobile computing device according to some embodiments.

Referring to FIG. 3, a system for provisioning a payment application in a mobile computing device includes a mobile computing device 100 on which a mobile payment application (or “payment application”) 200 is installed an operating. The system further includes a provisioning server 300 and a payment processing server 400. The mobile computing device 100, the provisioning server 300 and the payment processing server 400 may each be configured to communicate over a public data communications network 145, such as the Internet. Alternatively or additionally, these devices may be configured to communicate over one or more private data communications networks, such as Intranets, virtual private networks, mobile communications networks, or other communications networks.

Although illustrated as separate entities, the provisioning server 300 and the payment processing server 400 may be implemented as separate modules on the same computing device. The devices may be co-located and/or remotely located from one another. They may be operated by the same or different entities.

The provisioning server 300 may, for example, obtain the checksum of each supported version of a mobile payment server from a network node operated by a publisher of the payment application. In some embodiments, the provisioning server 300

In the following discussion, the following terms are used:

PK: Payment Key

PK_PS: Payment Key generated by provisioning server

PK_OD: Payment key ON device

CHECKSUM_P: payment application's signature or checksum obtained from publisher

CHECKSUM_C: payment application's signature or checksum calculated by payment application

PIN: user's PIN for payment

⊕—XOR/Exclusive OR operation

The provisioning server 300 maintains a database that stores a checksum of the latest payment application. The database may store checksums of different versions of a supported application, different mobile payment applications, etc. When a payment key is provisioned to a payment application, the payment key is XORed with a checksum of the version of the payment application that is being provisioned.

The provisioning server 300 thus generates the encrypted payment key for provisioning to the payment application as follows:

PK_PS=H(PK)=PK⊕CHECKSUM_P [1]

The payment application may further encrypt the payment key, for example, by XORing the encrypted payment key with a user PIN as follows:

PK_OD=PK_PS⊕PIN [2]

When the payment application generates a cryptogram for use in a financial transaction, the payment application can obtain the original payment key PK by calculating a checksum of itself and XORing the checksum with the stored payment key and the PIN as follows:

PK=PK_OD⊕CHECKSUM_C⊕PIN [3]

For Equation [3] to generate the correct payment key, both the checksum and the PIN must be correct. If either of them is incorrect, then the wrong payment key will be recovered. However, there is no way to verify if the payment key is wrong by brute force. Rather, the only way to verify if the payment key is correct is to attempt a transaction.

Operations according to some embodiments are illustrated in the flow diagrams shown in FIGS. 4A and 4B. Referring to FIG. 4A, a payment application 200 sends a provisioning request 22 to a provisioning server 300. The provisioning request includes the version of the payment application 200. The provisioning server 300 authenticates the request (block 24), for example, by verifying a user name and password provided with the provisioning request 22. The provisioning server 300 obtains a checksum of the version of the payment application identified in the provisioning request (block 26). The checksum may be obtained, for example, from a publisher of the payment application 200.

The provisioning server 300 encrypts the payment key using the function H(PK), which may be accomplished by XORing the payment key with the checksum as shown in equation [1] above. The provisioning server 300 then sends the encrypted payment key to the payment application 200 in a message 30. Finally, the payment application 200 further encrypts the payment key using the PIN according to equation [2] above and stores the encrypted payment key for later use (block 32).

Referring to FIG. 4B, when the payment application 200 is used in a transaction, the payment application 200 may first generate a checksum of itself (block 34). To secure against unauthorized checksum generation by the payment application 200, it may be desirable for the checksum generation code in the payment application to be coded in a native language, such as C or C++ which is harder to tamper with than if the checksum generation code were implemented in a language, such as Java.

The payment application 200 may obtain the PIN, for example, by prompting a user of the payment application 200 to enter the PIN (block 36). The payment application 200 may then recover the payment key PK by performing an XOR application on the stored payment key, the calculated checksum and the PIN as shown in equation [3] above (block 38).

Once the payment key is recovered, the payment application 200 may generate a cryptogram (block 40) and send the cryptogram to a payment processing server 400 along with a transaction request 42. The payment processing server analyzes the cryptogram and sends a transaction response 44 indicating whether or not the transaction is successful.

Operations according to further embodiments are illustrated in FIGS. 5A-5C. In the embodiments of FIGS. 5A-5D, an encoded checksum may be provided by a protected operating system component 165 of the operating system of the mobile device 100 on which the payment application 200 is running. The operating system component may, for example, be a service such as the Android Package Manager service. That is, rather than have the payment application calculate its own checksum, additional security may be provided by having the payment application obtain the checksum from the operating system component 165. This can ensure that the payment application cannot use a fake checksum to decrypt the payment key. The operating system service may be a protected operating system service that is protected by the operating system against tampering.

Referring to FIG. 5A, when the payment application 200 seeks to provision a payment key, the payment application 200 first requests a checksum value from the protected operating system component 165 (arrow 52). The protected operating system component 165 calculates a checksum H of the payment application (block 54) and encodes the checksum as H′ (block 56). The checksum H may be encoded using any suitable encoding or encryption technique. The encoded checksum H′ is then provided to the payment application 200 (arrow 58).

The payment application 200 may then send a provisioning request 60 to the provisioning server 300 including the encoded checksum H′. At this point, the payment application may discard the encoded checksum H′ so that it is not later available to the payment application 200. The provisioning server 300 authenticates the request (block 62) generates a payment key PK and encodes the payment key PK using the encoded checksum H′. The encoded payment key, which is indicated as H′(PK), is then sent by the provisioning server 300 to the payment application 200 in a response 66 to the provisioning request 60. The payment application 200 may then encode or encrypt the encoded payment key using a PIN as described above (block 68).

In other embodiments illustrated in FIG. 5B, the provisioning server 300 may obtain the encoded checksum H′ directly from the operating system component 165. Referring to FIG. 5B, after a payment application 200 sends a provisioning request 61 to the provisioning server 300, the provisioning server 300 requests a checksum from the protected operating system component 165 via a message 53. The protected operating system component 165 calculates a checksum H of the payment application (block 54) and encodes the checksum as H′ (block 56). The encoded checksum H′ is then provided to the payment application 200 (arrow 59).

The provisioning server 300 authenticates the request (block 62) generates a payment key PK and encodes the payment key PK using the encoded checksum H′. The encoded payment key, which is indicated as H′(PK), is then sent by the provisioning server 300 to the payment application 200 in a response 66 to the provisioning request 61. The payment application 200 may then encode or encrypt the encoded payment key using a PIN as described above (block 68).

FIG. 5C illustrates various operations associated with the generation of a cryptogram when the checksum is encoded as illustrated in FIG. 5A or 5B. Referring to FIG. 5C, when a payment application 200 needs to generate a cryptogram, the payment application 200 first requests a checksum from the protected operating system service 165 via a message 70. The operating system component 165 calculates a checksum H of the payment application (block 72) and encodes the checksum as H′ (block 74). The operating system component provides the encoded checksum H′ to the payment application 200 (arrow 76).

The payment application 200 may then obtain a PIN, for example, by prompting a user of the payment application 200 to enter the PIN (block 78). The payment application 200 may then recover the payment key PK by performing an XOR application on the stored payment key, the calculated checksum and the PIN as shown in equation [3] above (block 80).

Once the payment key is recovered, the payment application 200 may generate a cryptogram (block 82) and send the cryptogram to a payment processing server 400 along with a transaction request 84. The payment processing server analyzes the cryptogram and sends a transaction response 86 indicating whether or not the transaction is successful.

Referring to FIG. 5D, additional integrity checking can be provided by including the encoded checksum H′ along with the cryptogram in the transaction request 84. The processing server 400 can check the encoded checksum H′ to ensure the integrity of the payment application 200 that is making the request. The encoded checksum H′ may be provided earlier to the processing server 400 by the provisioning server 300 so that the processing server 400 is aware of the encoded checksum H′.

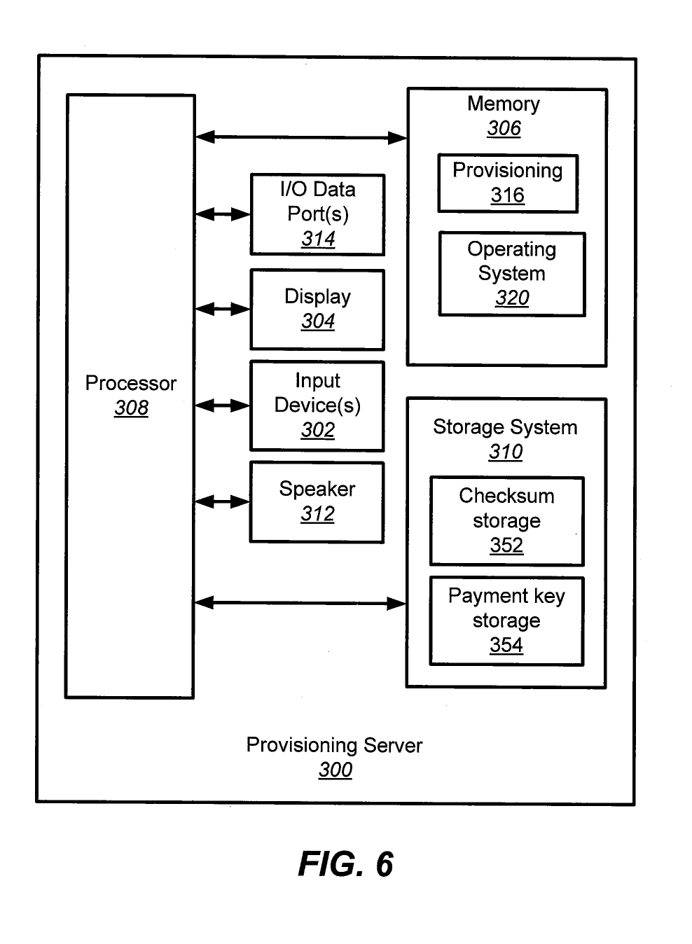

FIG. 6 illustrates aspects of a provisioning server 300 according to some embodiments. The provisioning server 300 includes a processor 308 that communicates with a memory 306, a storage system 310, and one or more I/O data ports 314. The provisioning server 300 may also include a display 304, an input device 302 and a speaker 312. The memory 306 stores program instructions and/or data that configure the provisioning server 300 for operation. In particular, the memory 306 may store a provisioning module 316 and an operating system 320. The provisioning module 316, among other tasks, performs the operations of transmitting payment keys to mobile payment apps and verifying the integrity of mobile payment apps as described herein.

The storage system 310 may include, for example, a hard disk drive or a solid state drive, and may include a checksum storage 352 that stores information regarding checksums of mobile payment apps that are being provisioned. The storage system 310 may also include a payment key storage 354 that stores payment keys that are provided to mobile payment apps.

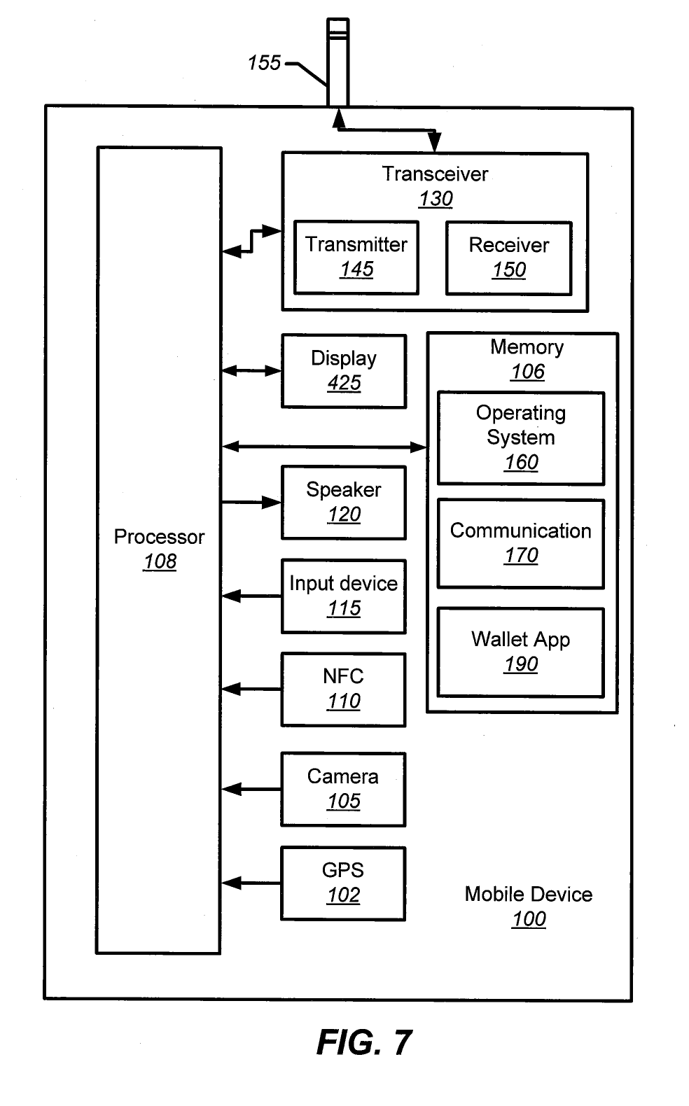

A mobile computing device 100 according to some embodiments is illustrated in FIG. 7. The mobile computing device 100 includes a processor 108 that communicates with a memory 106, a storage 185, and a transceiver 130. The transceiver 130 is coupled to an antenna 155 and includes a transmitter 145 and a receiver 150 that enable the mobile computing device 100 to communicate over one or more wireless data networks, such as WCDMA, 3G LTE, Wifi, and the like. It will be appreciated that a separate Wifi transceiver, Bluetooth transceiver, or other transceiver may also be included in the mobile computing device 100. The mobile computing device 100 may also include a display 125, one or more input devices 115, such as a keypad, touchscreen and/or microphone, a speaker 120, a near field communications (NFC) module 110, an RFID scanner 108, a camera 105 and a GPS receiver 102. The memory 106 stores program instructions and/or data that configure the mobile computing device 100 for operation. In particular, the memory 106 may store an operating system 160, a communication module 170, and a package delivery application (app) 190 that enables the mobile computing device 100 to perform operations described herein. The memory 106 may also store a wallet app 190 that contains payment card information, such as credit card and/or debit card information, and/or electronic payment account credentials (e.g. PayPal credentials).

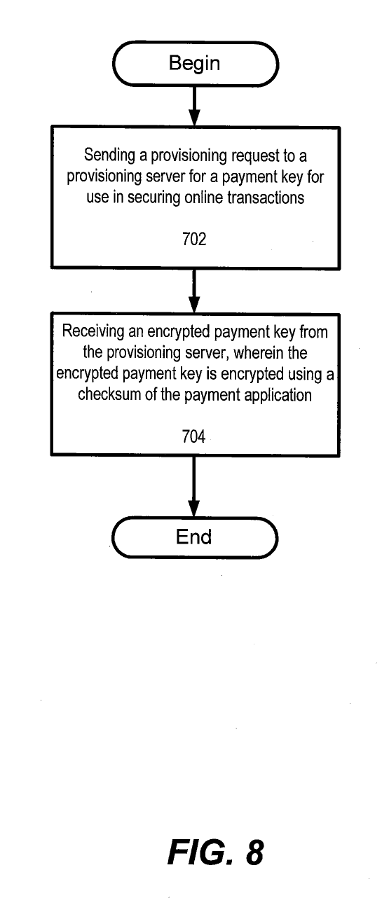

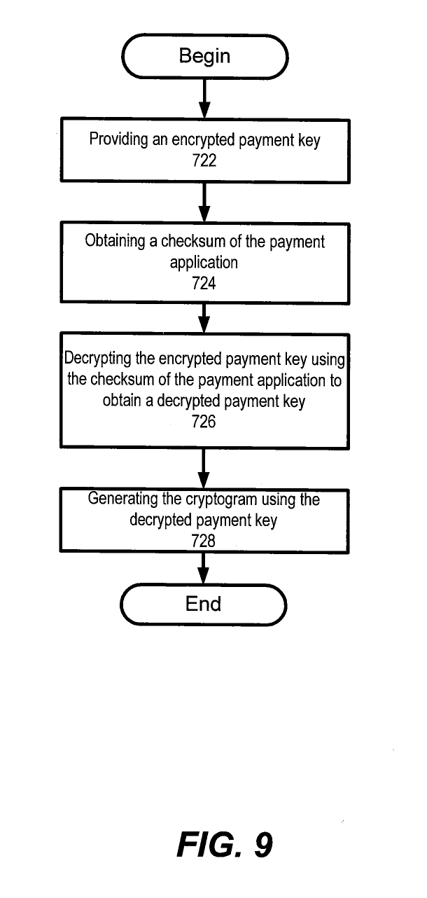

FIGS. 8 and 9 are flowcharts that illustrate operations of a payment application according to some embodiments.

Referring to FIGS. 3 and 8, a payment application 200 may obtain a payment key for use in securing financial transactions by first sending a provisioning request to a provisioning server 300 for a payment key (block 702). The payment application 200 then receives an encrypted payment key from the provisioning server 300, wherein the encrypted payment key is encrypted using a checksum of the payment application (block 704).

Referring to FIGS. 3 and 9, a payment application 200 may use the encrypted payment key as follows. First the payment application 200 obtains the encrypted payment key, for example by retrieving the encrypted payment key from storage (block 722). The payment application 200 obtains a checksum of the payment application 200 (block 724), for example, by performing a runtime calculation. The checksum may also be obtained, for example, by requesting the checksum from an operating system component. The payment application 200 decrypts the encrypted payment key using the checksum to obtain a decrypted payment key (block 726). In some embodiments, the payment key may also be decrypted using a PIN entered by a user.

Finally, the payment application 200 generates a cryptogram using the decrypted payment key (block 728). The cryptogram may be provided to a POS terminal, online retailer, ATM machine, etc., as part of a secured transaction.

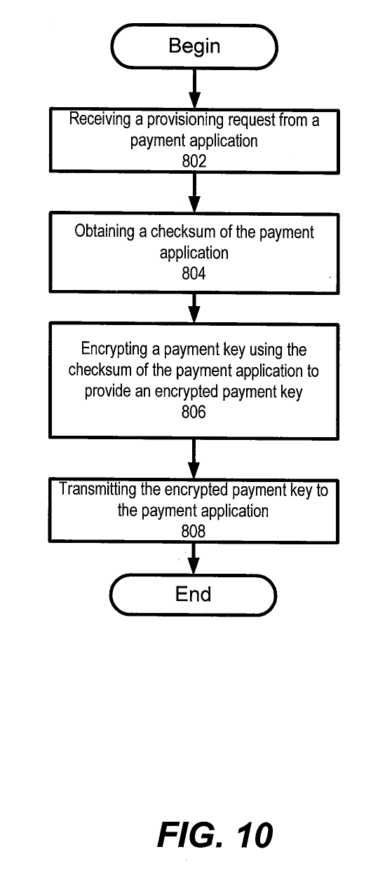

FIGS. 10, 11 and 12 are flowcharts that illustrate operations of a provisioning server according to some embodiments.

Referring to FIGS. 3 and 10, a provisioning server 300 receives a provisioning request from a payment application requesting provisioning of a payment key (block 802). The provisioning server 300 obtains a checksum of the payment application (block 804). For example, the provisioning server 300 may obtain the checksum of the payment application from a publisher of the payment application.

The provisioning server 300 generates a payment key and encrypts the payment key using the checksum of the payment application to provide an encrypted payment key (block 806) and transmits the encrypted payment key to the payment application (block 808).

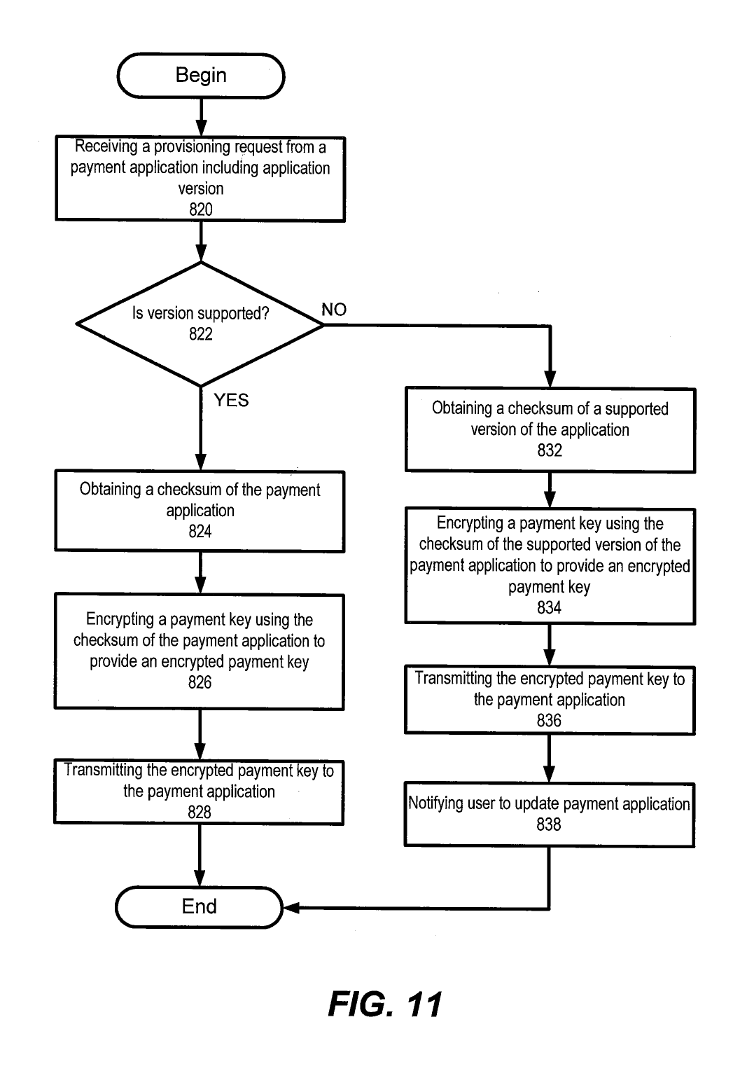

Referring to FIGS. 3 and 11, a provisioning server 300 receives a provisioning request from a payment application requesting provisioning of a payment key (block 820). The provisioning request may identify a version of the payment application. The provisioning server then checks to see if the identified version of the payment application is a supported version application (i.e., to ensure that the version of the payment application that is requesting a payment key is not outdated).

If the version is supported, then provisioning may occur as usual., i.e., the provisioning server 300 obtains a checksum of the payment application (block 824), generates a payment key and encrypts the payment key using the checksum of the payment application to provide an encrypted payment key (block 826) and transmits the encrypted payment key to the payment application (block 828).

If the version of the payment application that issued the provisioning request is not supported, the provisioning server 300 may in some embodiments simply reject the provisioning request and notify the payment application that an update is required to proceed. However, in embodiments illustrated in FIG. 11, the provisioning server 300 obtain a checksum of a supported version of the payment application (block 832), encrypts a payment key using the checksum of the supported version of the payment application to provide an encrypted payment key (block 834), transmit the encrypted payment key to the payment application (block 836), and notify the user to update the payment application to the version corresponding to the encrypted payment key. In that case, the user may use the newly provisioned payment key by simply updating the payment application to the supported version.

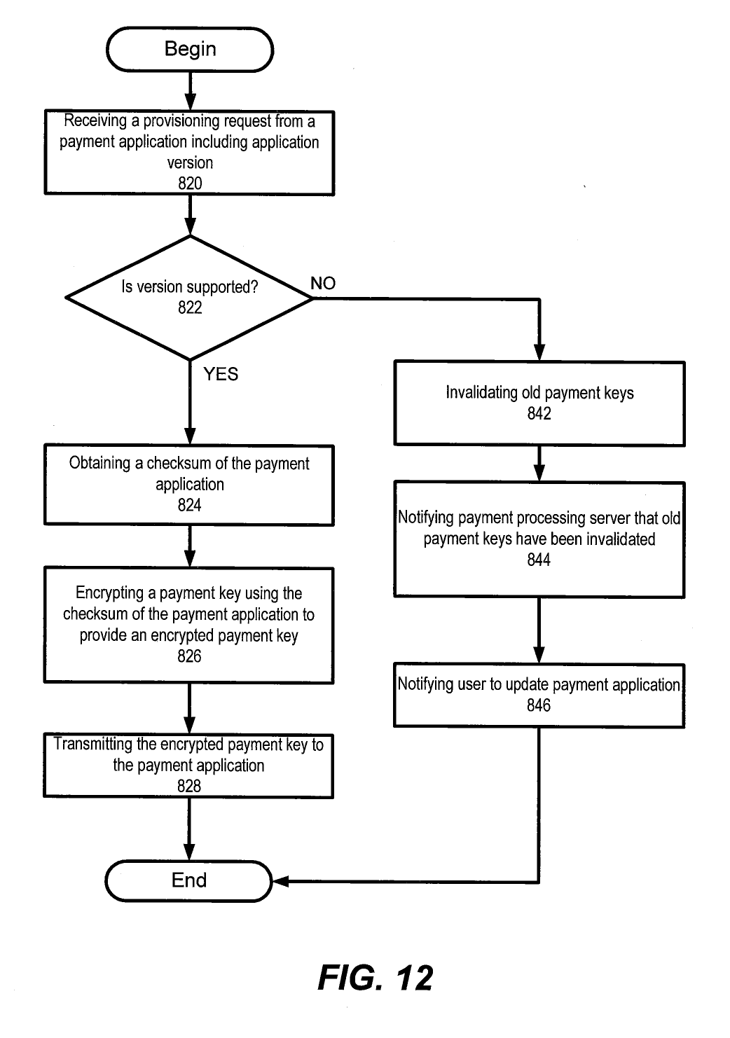

Referring to FIGS. 3 and 12, operations 820 to 828 are the same as described above with respect to FIG. 11, and will not be described further. In FIG. 12, if it is determined at block 822 that the version of the payment application that issued the provisioning request is not supported, then in addition to or instead of the operations illustrated in FIG. 11, the provisioning server 300 may invalidate payment keys previously issued to the payment application (block 842). The provisioning server 300 may notify a payment processing server 400 that the payment keys have been invalidated (block 844), and may notify the user to update the payment application to a supported version (block 846).

In the above-description of various embodiments of the present disclosure, aspects of the present disclosure may be illustrated and described herein in any of a number of patent-eligible classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
performing operations as follows on a processor of a computing device:
receiving a provisioning request from a payment application, the provisioning request requesting allocation of a payment key;
obtaining a checksum of the payment application;
generating the payment key;
encrypting the payment key using the checksum of the payment application to provide an encrypted payment key; and
transmitting the encrypted payment key to the payment application.

2. The method of claim 1, wherein obtaining the checksum of the payment application comprises sending a message to a network node operated by a publisher of the payment application and receiving the checksum of the payment application in response from the network node operated by the publisher of the payment application.

3. The method of claim 1, further comprising:
receiving a version number of the payment application, wherein obtaining the checksum of the payment application comprises sending a message to a network node operated by a publisher of the payment application including the version number of the payment application and receiving the checksum from the network node operated by the publisher of the payment application in response.

4. The method of claim 1, further comprising:
receiving a version number of the payment application;
determining if the version number of the payment application is supported for mobile payments, and in response to determining that the version number of the payment application is not supported for mobile payments, generating an encrypted payment key by encrypting the payment key using a checksum for an updated version of the payment application that is supported for mobile payments.

5. The method of claim 1, further comprising:
identifying an installed version of the payment application;
determining if the installed version of the payment application is an outdated version of the payment application;
in response to determining that the installed version of the payment application is an outdated version of the payment application, sending a message to a user of the payment application indicating that the payment application should be upgraded to a newer version before generating the payment key and preventing generation of a payment key for the payment application until the payment application has been upgraded to the newer version.

6. The method of claim 5, further comprising:
invalidating payment keys generated using a checksum of the installed version of the payment application in response to determining that the installed version of the payment application is an outdated version of the application.

7. The method of claim 6, further comprising notifying a payment processing server that the payment keys generated using a checksum of the installed version of the payment application have been invalidated.

8. The method of claim 5, further comprising:
in response to determining that the installed version of the payment application is an outdated version of the payment application, obtaining a checksum of a current version of the payment application and encrypting the payment key using the checksum of the current version of the payment application to provide the encrypted payment key.

9. The method of claim 1, wherein obtaining the checksum of the payment application comprises sending a request for the checksum to an operating system component on a processing device on which the payment application is running and receiving the checksum of the payment application from the operating system component.

10. A computer system, comprising:
a processor; and
a memory coupled to the processor, the memory comprising computer readable program code embodied therein that, when, executed by the processor, causes the processor to perform operations comprising:
receiving a provisioning request from a payment application, the provisioning request requesting allocation of a payment key;
obtaining a checksum of the payment application;
generating a payment key;
encrypting the payment key using the checksum of the payment application to provide an encrypted payment key; and
transmitting the encrypted payment key to the payment application.

11. A method, comprising:
performing operations as follows on a processor of a computing device:
receiving an encrypted payment key from a provisioning server;
obtaining a checksum of a payment application;
decrypting the encrypted payment key using the checksum of the payment application to obtain a decrypted payment key;
generating a cryptogram for use in a secure transaction by the payment application using the decrypted payment key; and
initiating a secure transaction using the cryptogram.

12. The method of claim 11, wherein the checksum of the payment application comprises a hash of the payment application.

13. The method of claim 11, wherein decrypting the encrypted payment key comprises performing an exclusive-OR operation on the encrypted payment key and the checksum of the payment application.

14. The method of claim 11, further comprising:
obtaining a personal identification number (PIN) for a user of the payment application;
wherein decrypting the encrypted payment key comprises decrypting the encrypted payment key using a combination of the checksum of the payment application and the PIN to obtain the decrypted payment key.

15. The method of claim 14, wherein decrypting the encrypted payment key comprises performing an exclusive-OR operation on the encrypted payment key, the checksum of the payment application and the PIN.

16. The method of claim 11, further comprising:
sending a provisioning request to the provisioning server requesting that the provisioning server provide the payment key for use in securing online transactions.

17. The method of claim 16, further comprising:
obtaining a personal identification number (PIN) for a user of the payment application;
encoding the encrypted payment key using the PIN to obtain a PIN-encoded encrypted payment key; and
storing the PIN-encoded encrypted payment key.

18. The method of claim 16, wherein the provisioning request includes a version number of a payment application that is requesting provisioning.

19. The method of claim 11, wherein obtaining the checksum comprises obtaining the checksum from an operating system component that is running on the computing device.
